(19) United States
(12) Patent Application Publication
(10) Pub. No.: US 2005/0146200 A1
(43) Pub. Date: Jul. 7, 2005

(54) Methods of manufacturing toothbrushes

(75) Inventors: Bernd Stein, Schmitten (DE); Mark McConnell, Oola (IE); Joseph Depuydt, Quincy, MA (US); Michael Vankov, Schmitten (DE); Ahmet Cem Firatli, Wiesbaden (DE)

Correspondence Address: FISH & RICHARDSON PC, 225 FRANKLIN ST, BOSTON, MA, 02110, US

(73) Assignee: Braun GmbH, a Kronberg, Germany corporation

(21) Appl. No.: 11/074,049

(22) Filed: Mar. 7, 2005

Related U.S. Application Data
(62) Division of application No. 10/236,116, filed on Sep. 6, 2002.

(30) Foreign Application Priority Data
Sep. 6, 2001 (DE) 10143673.4

(51) Int. Cl. A46D 3/00; B29C 45/14

(52) U.S. Cl. 300/21; 264/279

(57) ABSTRACT

A method is provided for manufacturing a function element carrier with function elements, for example, individual tufts made up of bristles and/or massage elements, interproximal cleaning elements, or other elements designed to be fastened to a toothbrush and also perform special functions. The function elements are equipped at their ends intended for anchoring in a toothbrush with an anchor, retainer or axle element. The method includes: (a) inserting several function elements in corresponding recesses of an injection mold, said injection mold being connected via grid or bar shaped channels formed in a die to recesses in the areas of the anchoring ends of the function elements; (b) filling the grid or bar shaped channels with liquefied plastic material and injecting said material at the anchoring ends of the function elements or embedding them therein; and (c) allowing the plastic material to cool and removing a function element carrier made up of a grid or bar shaped plastic frame and the function elements. Function element carriers and toothbrushes are also provided.

### CROSS-REFERENCE TO RELATED APPLICATION

This application claims the benefit of German application serial number 101 43 673.4 filed Sep. 6, 2001.

### TECHNICAL FIELD

This invention relates to methods for manufacturing toothbrushes.

### BACKGROUND

Methods for manufacturing plastic toothbrushes are already known from the art. For example, DE-OS 3403341 describes a joining method by which the bristle receiving side of a bristle carrier and, where applicable, the fixing ends of the bristles are transformed into a soft plastic state by melting and then joined by pressing together. In this method it suffices to melt the bristle carrier only locally in those places where individual bristle tufts are to be fixed. When the ends of the bristles in a tuft are melted, the thermoplastic material flows together and forms an enlargement that simultaneously acts as the basis for joining the bristles themselves together. Depending on the pair of materials used for the bristles and the bristle carrier the result is a welded connection in which coalescence of two materials takes place, or a joined connection in which the bristles have their enlarged ends enclosed by the soft plastic material of the bristle carrier, being thus held captive.

From DE-OS 2812746 it is known to feed a continuous bristle strand to a device, to cut the required length of bristle tuft off the strand, and to simultaneously heat the receiving side of the bristle carrier and the bristle ends and then bring them together and fix them in this joined position until a firm connection is established after sufficient cooling. With this method the feeding, cutting, melting, joining and cooling operations are all performed on a single work station.

Further, DE 19932377-A1 describes a method for manufacturing brushes with a plastic bristle carrier and an attached set of bristles consisting of individual plastic bristles or plastic bristles arranged in tufts. In this method the ends of the bristles or tufts at the fixing end are melted to form an enlargement. Enlargements of adjacent bristles of tufts are joined together by the remolding and displacement of the plastic mass, the joints being subsequently embedded in the plastic material of the bristle carrier. The method uses a molding tool to transform adjacent enlargements into a defined supporting structure and connecting bars, following which a short length of the supporting structure and protruding bristles is embedded in the plastic material of the bristle carrier.

The method for manufacturing brushes disclosed in DE 19542393 A1 works along similar lines. In this method tufts of bristles are held in an array corresponding to their position in the field of bristles, after which their fixing ends are melted in this position and, as a result of this melting, joined together to form a bristle tuft unit. In this method the part connecting the fixing ends is also produced from the melt while melting the fixing ends.

EP 0326634 A1 discloses a method for manufacturing bristle products, comprising the steps of passing tufts of individual bristles or bristle strands through channels and sleeves extending the channels, and inserting them in a mold for the bristle carrier. The bristle tufts are then melted by the action of heat at their ends proximate the mold in order to form an enlargement, and the enlargement created at the ends of the bristles during melting is moved into sealing engagement with the mouth of the sleeve projecting into the mold. The bristles and the sleeve are held in position while the mold is filled, e.g., by injection molding. This method is also referred to as the in-mold process.

WO 99/11156 discloses a method for manufacturing fields of bristles. Here, too, the bristles in the area of the undercut are heated so that the plastic of the bristles produces a melt or plastic mass that fills the undercut either fully or partly, the subsequently solidifying plastic mass producing the positive-engagement connection between the bristles or bristle tufts and the undercuts, and hence the holding plate. It is thus possible for the undercuts to be formed either before or at the same time as the ends of the plastic bristles are melted.

Further, DE 19937481 A1 proposes a two-component injection molding method for manufacturing a brush comprised of a bristle carrier having at least two essentially parallel layers of dissimilar plastics, which methods includes fastening the bristles to at least one of the layers. The layer of the bristle carrier facing away from the bristles has openings that are closed on the peripheral side and filled with the plastic of the other layer. The result is a positive-engagement connection between the two dissimilar plastic layers.

One disadvantage of the previously mentioned publications is that after the function elements are produced it often requires an unacceptable effort to isolate and approximately align them for further processing before they are subsequently fixed in the correct position in a bristle carrier.

### SUMMARY

In preferred implementations, the present invention provides an improved and simplified method for manufacturing function elements for use in toothbrushes, which enables the function elements to be manufactured with greater ease and economy. This method is intended in particular to enable the low-cost manufacturing and integration of function elements in toothbrush production. The invention also features function elements manufactured by the previously mentioned method that can be handled more efficiently during their further processing. Additionally, the invention features toothbrushes that are equipped in a simple and economical manner with easy-to-use function elements.

Preferred methods of the invention also enable the simple and economical manufacturing of toothbrushes with function elements. Function elements according to the inventions are understood to include tufts of bristles of various filaments and other elements that perform a special function on a toothbrush, for example massage elements and interproximal cleaning elements.

In one aspect, the invention features a method for manufacturing a function element carrier with function elements, for example, individual tufts made up of bristles and/or massage elements, interproximal cleaning elements, or other elements designed to be fastened to a toothbrush and also perform special functions. The function elements are equipped at their ends intended for anchoring in a toothbrush with an anchor, retainer or axle element. The method includes: (a) inserting several function elements in corresponding recesses of an injection mold, said injection mold being connected via grid or bar shaped channels formed in a die to recesses in the areas of the anchoring ends of the function elements; (b) filling the grid or bar shaped channels with liquefied plastic material and injecting said material at the anchoring ends of the function elements or embedding them therein; and (c) allowing the plastic material to cool and removing a function element carrier made up of a grid or bar shaped plastic frame and the function elements.

Preferred methods also enable various function elements to be attached to a function element carrier in a predetermined orientation that allows for simple integration and secure anchoring in a brush head or a toothbrush hand piece. For example, several tufts may be inserted in an injection mold or part of an injection mold. The injection mold is also referred to as “mold bar”. All the elements are interconnected by channels called “hot runners,” in order to convey the liquid thermoplastic material to the respective destinations. The function elements themselves can be arranged preferably on the grid bars, i.e., on the longitudinal and cross bars of the plastic frame.

The grid type array of channels can be made to correspond in its dimensions and spacings to the positions occupied at a later stage by the function elements in a brush product. This is not necessary, however. Rather, the array can be based on machine parameters dictated, for example, by the particular automatic assembly unit or the like. In the following description the points of intersection of the channels will be designated as grid points.

With the method of the invention, a plurality of tufts may be equipped in a single operation in one tool with anchorage devices while at the same time a plastic frame is provided, thus producing an easy-to-handle function element carrier comprising aligned and sorted function elements, with which a plurality of function elements can be inserted in a tool and have plasticized material injection molded around them in a single operation, so that a completely finished toothbrush head is obtained. With this method of the invention it is possible to substantially shorten the cycle time for manufacturing a toothbrush head.

The method may also include, in a next step, transferring the function element carrier to a further processing station in which the function elements are severed from the plastic frame, and subsequently the anchoring ends of the function elements are secured in a brush holder. The grid or bar shaped plastic frames may be separated from the function elements either before or after inserting the function elements in a tool so that only the function elements remain in the toothbrush head. In this process, plastic material can be injection molded around the individual function elements so that they then form a finished toothbrush head, or alternatively, the individual function elements can be inserted in openings provided in a toothbrush head manufactured in a prior injection molding operation where they engage behind undercuts, being thus either rotatably or pivotally or non-rotatably fastened in the brush holder. Alternatively, they can also be fastened in the brush holder by special anchorage devices such as wires, adhesives, wedges, or also by caulking, etc. It is also possible, however, to heat both parts to a temperature causing them to fuse intimately together.

The grid or rod shaped plastic frame may include grid bars and grid points between which tapers are formed. Tapers can be formed during the manufacturing process at the ends of the anchorage, retainer or axle elements of the function elements and can then be used during further processing as, for example, breaking, cutting or parting points for easy disconnection of the function elements from the plastic frame. Separating the function elements can also be performed by receiving them all in openings of a progressive die and severing the tapers in a single operation. The separated plastic frame can then be removed from the progressive die, and the function elements can be inserted in a brush holder, or be immediately embedded in molding material in the progressive die to form a brush head or a complete toothbrush.

The present invention enables function elements of brush products to be simultaneously manufactured with integrated handling aids for subsequent further processing, in addition to providing the possibility of molding special assembly aids or function faces, e.g., anchors, motion axles or the like, on these function elements. This process enables the most diverse material combinations to be used including, for example, tufts of bristles made of extruded nylon filaments combined with embedded anchors or axles made of an elastomer plastic material, massage elements made of soft material, etc.

The function elements may be equipped with undercuts for securing to the plastic frame. The undercuts may be formed, in the case where bristle tufts are involved, for example, by melting the rear tuft element. In the case of massage elements or the like, which are manufactured either from a thermoplastic material or an elastomer plastic material or even a combination of several dissimilar materials, such undercuts can be provided in advance by suitable design measures so that in this process step they only need to be prepared, as by heating, for further processing. Using liquid plastic mass, an anchor, retainer or axle element can then be injection molded on these undercuts.

The method may also include, in a next step, transferring the function element carrier to a further processing station in which the carrier is embedded in a brush holder by injection molding plastic material around it, so that subsequently only the anchoring ends of the function elements are enclosed by the brush holder. This allows the function elements to be integrated in the brush holder in a particularly easy manner. In this process the grid shaped plastic frame can also be configured like a skewed parallelogram or adopt any other desired structure to which the function elements are fastened. The function element carrier is manufactured in a prior operation in accordance with the desired array and position of the function elements on the brush holder so that the function elements already occupy this final geometrical position on the toothbrush.

The grid or rod shaped plastic frame may be made up of grid bars forming grid points at the intersections, between which tapers are formed, and the plastic frame may be deformed before being embedded in the molding material of the bristle holder so that the function elements assume their desired position in the brush holder following embedding. In this case, the function elements in the plastic frame, after being manufactured and shortly before being integrated in a toothbrush, are relocated in the plastic frame within certain limits by relative displacement of the longitudinal bars, so that the function elements are arranged as they should be later on in the brush head. The advantage of this method is that it does not entail maneuvering individual function elements but a function element carrier on which all the function elements required for a brush head are already arranged. By relative displacement of the longitudinal bars it is possible to position the function elements closer together than would generally be possible by maneuvering individual function elements, because the use of picker devices to hold and guide said function elements would require certain spacings in between. In this embodiment of the invention the function element carriers would generally be integrally molded in the brush head.

Various function elements of elastomer plastic may be provided on the plastic frame. If desired, the most diverse function elements made of dissimilar or like materials can be arranged on one function element carrier. For example, provision can be made for tufts of bristles comprising various filaments, massage elements, or other elements performing various special functions. All these function elements can subsequently be inserted in a brush body in a single operation.

In another aspect, the invention features a function element carrier including a plurality of function elements equipped at their ends intended for fastening in a toothbrush with an anchor, retainer or axle element, each function element being fastened to a grid or rod shaped plastic frame through its anchor, retainer or axle element.

Because, in this aspect, the function elements are fastened by their ends intended for anchoring in a brush head to a grid or bar shaped plastic frame, the resulting unit is easy to handle during its further processing. As a result, it is possible to insert a complete set of function elements in a tool and to join it to a brush holder, e.g., by embedding it in a molding material, or by mechanically inserting the unit in a prefabricated brush holder. This eliminates an elaborate separation of function elements, which, after their production, are held in a magazine where their bristles tend to interlock. Moreover, the function elements can already adopt the position they are required to occupy later on on the brush holder. Integrated handling aids can be used for further processing, as well as special assembly aids or function faces (anchors, motion axles, etc.) that can be injection molded to these function elements. With these function elements it is also possible to use the most diverse material combinations.

The grid or rod shaped plastic frame may be comprised of connected grid bars forming grid points at the transitions to the anchoring ends, with tapers being provided therebetween. These tapers may enable better separation of the function elements from the plastic frame, i.e., making it easier to break, cut or remove in some other way the individual function elements from the plastic frame.

Additional assembly aids or function faces may be arranged on the function elements, e.g., by molding the assembly aids or function faces on the individual function elements. Such assembly aids or function faces may include, for example, anchors, motion axles or other elements that enable the function elements to be fastened or supported in the subsequently used brush holder.

It is possible to manufacture the function elements and the plastic frame from dissimilar plastic materials. This makes sense in particular if, for example, the plastic frame not required in a toothbrush is discarded or re-used, enabling it to be made of an inferior or other grade of plastic.

The function elements may be provided with undercuts at their anchoring ends for fastening to the plastic frame. These undercuts, if they are pivotally mounted in the brush holder, enable simple insertion in the provided recesses so that, like a snap-fastener, they can be inserted once, after which they can no longer be removed from the brush holder and yet are pivotal in one or several directions as required.

In another aspect, the invention features a toothbrush with function elements that are each equipped at their ends intended for anchoring in a brush holder of a toothbrush with an anchor, retainer or axle element, wherein the individual function elements are connected, through their anchor, retainer or axle elements to a grid or rod shaped plastic frame which is secured in the brush holder such that tooth cleaning ends of the function elements protrude from the brush holder.

Thus, the toothbrush may be comprised of a plastic frame with several function elements that are inserted together with the plastic frame in the brush holder, wherein however only those sections intended to treat the teeth or the oral cavity protrude from the toothbrush head. A toothbrush of this type affords economy of manufacture and permits a random array of the individual function elements, possibly consisting of various types, on the brush holder.

In a further aspect, the invention features a toothbrush including function elements that are each equipped at their ends intended for anchoring in a brush holder of a toothbrush with an anchor, retainer or axle element, wherein said anchor, retainer or axle elements include breaking, parting or cutting faces.

The toothbrush may have function elements that were previously severed from their plastic frame and integrated as individual elements in the brush holder, i.e., they are embedded in plastic molding material in such a way as to produce a brush holder of the predetermined shape, or they are fixedly seated in individual recesses provided for this purpose in a prefabricated brush holder. The breaking, parting or cutting faces may be fully enclosed by the plastic material if the anchor, retainer or axle elements are embedded. If they are pivotally inset in recesses, the breaking, parting or cutting faces can serve as lateral stop faces.

At least some of the function elements may be made from an elastomer plastic material. The toothbrush of the invention may include various types of function element performing different types of cleaning function such as plaque removal, gum massage, whitening of the teeth, or other advantageous tooth cleaning functions.

Further embodiments and advantages of the present invention will be described in the following with reference to the accompanying drawings. In the drawings,

### DESCRIPTION OF DRAWINGS

FIG. 1 is a perspective view of a function element carrier of the invention, comprising function elements manufactured in accordance with a method of the present invention;

FIG. 2 is a top plan view of the function element carrier of FIG. 1 after the two outer longitudinal bars have been displaced relative to the inner longitudinal bar;

FIG. 3 is a perspective view of a further function element carrier of the invention, showing function elements and, on the outer periphery, upwardly extending rods which are intended to protect the individual function elements from damage or external wear during transportation;

FIG. 4 is a perspective view of a brush holder embodiment showing function elements manufactured in accordance with the method of the invention; and

FIG. 5 is a perspective view of another brush holder embodiment showing function elements manufactured in accordance with the method of the invention.

### DETAILED DESCRIPTION

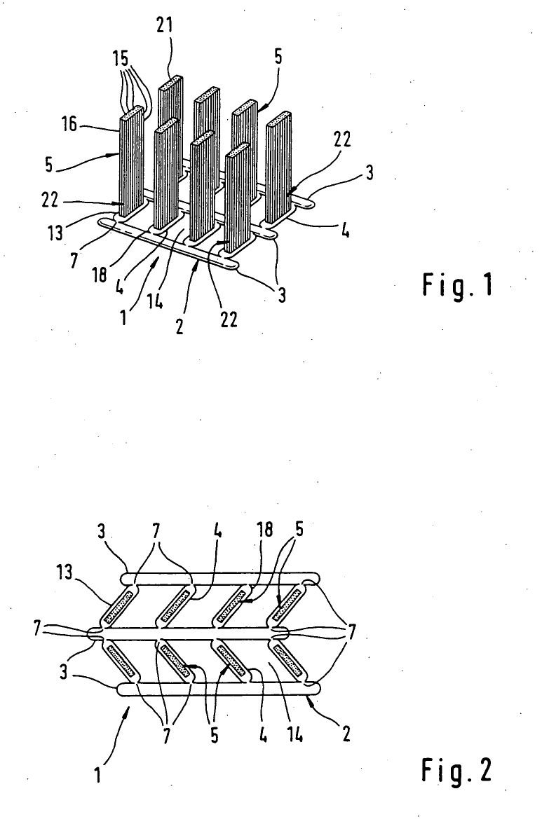

FIG. 1 is a perspective view of a function element carrier 1 according to the invention, which was manufactured by the method of the invention. The function element carrier 1 includes a grid or bar shaped plastic frame 2 made preferably from a thermoplastic material.

As used herein, the term “thermoplastic material” refers to any plastic that can be melted by heating. Thermoplastic materials include polystyrenes and polystyrene copolymers, copolymers of polyvinyl chloride and polyvinyl chloride acetate, polyfluorides and copolymers thereof, polyamides, polyimides, polyester, polypropylene, and polyurethanes.

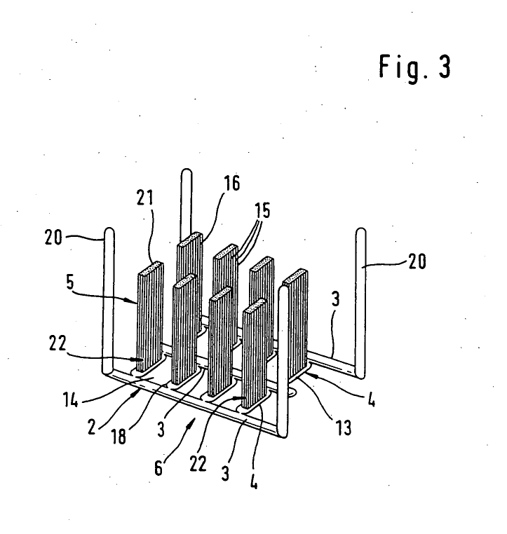

According to FIGS. 1 to 3 the plastic frame 2 is made up of grid bars comprising, in the embodiment shown, three longitudinal bars 3 which are interconnected at grid points 7 by cross bars 4. The cross bars 4 are distinctly shorter than the longitudinal bars 3, forming rectangles in FIGS. 1 and 3, and parallelograms in FIG. 2. Depending on the geometric setup they can, however, be longer, curved or of some other shape. It is only important that they be interconnected with each other and with the function elements.

According to FIGS. 1 to 3 the cross bars 4 have tapers 18 in advance of the grid points 7, thus creating a narrow transition to the longitudinal bars 3. On the one hand this creates movable grid points 7 so that, by displacing the middle longitudinal bar 3 relative to one or several outer longitudinal bars 3 as shown in FIG. 2, the function elements 5 can be arranged in more or less arrow shape in the plastic frame 2. On the other hand the tapers 18 enable the individual function elements 5 to be severed more easily.

In the embodiments shown in FIGS. 1 to 3, the cross bars 4 can form, on their anchoring sides 22, anchor, retainer or axle elements 13 for the upwardly extending tufts 16. The anchor, retainer or axle elements 13 extend almost to the longitudinal bars 3; for injection molding reasons they can also be shorter, however, so that sections of cross bars (not shown) adjoin the tapers 18 and merge into the longitudinal bars 3. The tufts 16 are comprised of a plurality of close lying individual bristles 15 and, in combination with the anchor, retainer or axle elements 13, form a function element 5 as shown in FIGS. 1 to 3.

Considering that the function element carrier 1 of FIGS. 1 to 3 is a schematic representation designed to serve as an example, the number of grid fields 14 formed by the longitudinal and cross bars 3,4 was restricted. It will be appreciated, however, that any number is possible for the purposes of the invention. Individual grid fields 14 can have different dimensions and shapes.

According to FIGS. 1 to 3 the bristles or filaments 15 are preferably made of nylon and are anchored in the cross bars 4. The one-piece function element carrier 1 shown in FIGS. 1 and 2 can be mounted in its illustrated form on a brush holder 8 and be connected to it, or it can be brought in a preparatory step into the required shape as shown in FIG. 2, for example, whereupon plasticized material is injection molded at and around it wholly or in part, thus creating a complete toothbrush head with or without a hand piece. This step involves displacing essentially the two outer longitudinal bars 3 relative to the inner longitudinal bar 3. Consequently, the cross bars 4 articulated to the locations of the grid points 7 are equally displaced, and the function elements 5 can thus be arranged in wedge shape in cleaning direction. In this process the grid fields 14 change their shape to parallelograms. With this method it is possible in particular to produce complex bristle arrays or arrangements of brushes with massage elements made of elastomer plastic material or pure massage elements made solely of elastomer plastic material in a parallel process to the brush holder, and to join them together when both process lines are merged.

FIG. 3 shows a function element carrier 6 that essentially corresponds to the function element carrier 1 of FIG. 1 but differs in that supports are molded to the outer corners of the outer longitudinal bars 3 in the form of vertically upwardly extending rods that protrude upwardly beyond the tooth-cleaning ends 21 of the tufts 16. These rods 20 protect the bristles 15 from damage and soiling during transportation and handling of the function element carrier 1. The rods 20 are removed from the plastic frame 2 before the function element carrier 6 is inserted. If, on the other hand, only the individual function elements 5 are inserted in a brush holder 8, 11, the complete plastic frame 2 with the rods 2 are first removed from the function elements 5.

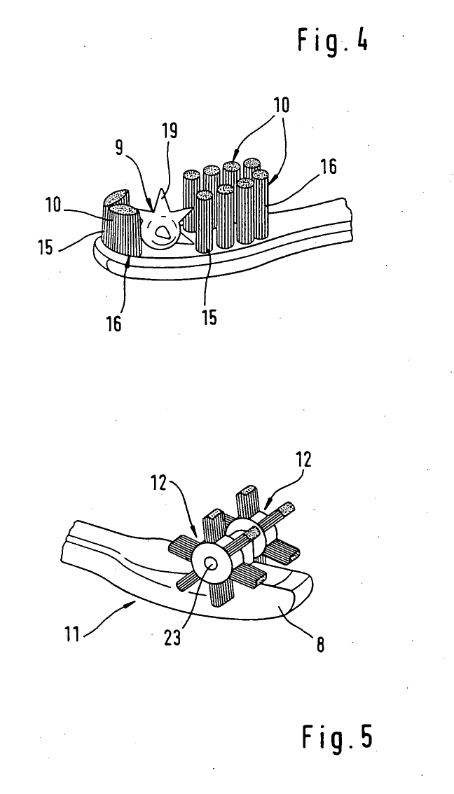

An embodiment of a brush holder 8 with various function elements 9, 10 is shown in FIG. 4. In this embodiment the brush holder 8 carries in its forward section a function element 9 with conically pointed studs 19, which is constructed as a spherical massage element. The massage element 9 is made of an elastomer plastic material, being to a certain extent shielded from the tip of the brush holder 8 by a tuft 16 with an essentially U-shaped cross section acting as a further function element 10. Further large tufts 16 or other massage elements are also provided as additional function elements 10.

A grid shaped plastic frame (not visible in FIG. 4 because it is enclosed by the brush holder 8) acts as a function element carrier for the massage element 9 and for the function elements 10 configured as tufts 16. The function element carrier is adapted so that the function elements 9, 10 adopt their position shown in FIG. 4. Then the lower sections (not visible because they are enclosed by the brush holder 8) of the function elements are fastened together with the plastic frame to the brush holder 8, or are connected therewith as by partially embedding them in or injecting molding material at them.

A further embodiment of a brush holder with function elements 12 for special functions is shown in FIG. 5. In this embodiment the brush holder 11 carries paddlewheel shaped function elements 12 intended to perform cleaning and massage functions in a person's oral cavity (not shown). The paddlewheel shaped function elements 12 are rotatably mounted on a common axle 23.

Here, too, the function elements 12 are initially connected to a grid or bar shaped plastic frame (not visible in FIG. 5 because it is enclosed by the brush holder). The process involves in particular supporting the rotary axle 23 of the paddle shaped function elements on the plastic frame. The plastic frame itself is then transferred to a work station where it is fastened to the brush holder 11 by welding or adhesive bonding, by embedding the grid bars in injection molding material, or some by other method.

1. A method of manufacturing a function element carrier including function elements, said function elements being equipped at their ends intended for anchoring in a toothbrush with an anchor, retainer or axle element, said method comprising the following steps:
inserting several function elements in corresponding recesses of an injection mold, said injection mold being connected via grid or bar shaped channels formed in a die to recesses in the areas of the anchoring ends of the function elements;
filling the grid or bar shaped channels with liquefied plastic material and injecting said material at the anchoring ends of the function elements or embedding them therein; and
allowing the plastic material to cool and removing a function element carrier comprising a grid or bar shaped plastic frame and the function elements.

2. The method according to claim 1, comprising, in a next step, transferring the function element carrier to a further processing station in which the function elements are severed from the plastic frame, and subsequently the anchoring ends of the function elements are secured in a brush holder.

3. The method according to claim 1 or 2, wherein the grid or rod shaped plastic frame includes grid bars and grid points between which tapers are formed.

4. The method according to claim 1, wherein additional assembly aids or function faces are injection molded on the function elements.

5. The method according to claim 4, wherein said assembly aids or function faces are configured as anchors or motion axles.

6. The method according to claim 1, wherein the function elements and the plastic frame are fabricated from dissimilar plastic materials.

7. The method according to claim 1, wherein the function elements are equipped with undercuts for securing to the plastic frame.

8. The method according to claim 1, comprising in a next step transferring the function element carrier to a further processing station in which said carrier is embedded in a brush holder by injection molding plastic material around the carrier, such that subsequently only the anchoring ends of the function elements are enclosed by the brush holder.

9. The method according to claim 8, wherein the grid or rod shaped plastic frame is made up of grid bars forming grid points at the intersections, between which tapers are formed, and wherein the plastic frame is deformed before being embedded in the molding material of the bristle holder so that the function elements assume their desired position in the brush holder following embedding.

10. The method according to claim 1 or 8, wherein various function elements of elastomer plastic are provided on the plastic frame.

11. The method according to claim 1 wherein the function elements include elements selected from the group consisting of tufts of bristles, massage elements, and interproximal elements.

12-21. (canceled)
